(19) United States
(12) Patent Application Publication
(10) Pub. No.: US 2009/0028227 A1
(43) Pub. Date: Jan. 29, 2009

(54) Method and device for interception of data transiting on a link in an Ethernet network

(75) Inventors: Frederic Nouis, Plaisance Du Touch (FR); Alban Le Men, Blagnac (FR); Eddie Gambardella, Blagnac (FR); Bruno Baudot, Ecully (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Airbus France, Toulouse (FR)

(21) Appl. No.: 11/446,248

(22) Filed: Jun. 5, 2006

(30) Foreign Application Priority Data
Jun. 9, 2005 (FR) 05 51549

(51) Int. Cl. H04B 17/00

(52) U.S. Cl. 375/224

(57) ABSTRACT

The invention relates to a method and device for real time interception of data transported on several links in an Ethernet network. With this method:
data transported on transmission lines (Tx+ et Tx−) and/or reception lines (Rx+ et Rx−) on each of these links are tapped simultaneously using couplers,
these data are copied, amplified and sent to at least one test equipment.

### TECHNICAL DOMAIN

The invention relates to a method and a device for interception of data transiting on a link in an Ethernet network, for example an AFDX network.

### STATE OF PRIOR ART

Integration, test and searches for defects in Ethernet networks, for example in avionics networks, require real time interception or <<spying>> of data transiting on the links in these networks.

Prior art includes data interception devices or <<taps>> used to recover or tap such information. But these devices have the following defects:
the spied information is deformed by the tapping,
these devices are not compatible with use in aircraft, particularly due to the connectors used.

Document reference [1] at the end of the description thus describes such data taps. In this document, the announced attenuation is less than 5 dB. But such an attenuation of 5 dB is enormous. Therefore the described devices are not transparent to tapping.

One standard embodiment of a data tapping method according to prior art is shown in FIG. 1. A data interception device 10 used for coding and decoding of Ethernet data transmitted on transmission lines Tx+ and Tx−, is connected to these transmission lines Tx+ and Tx− 11 and 12 through an insulator 13. The disadvantage of this type of embodiment is that it disturbs the spied link.

The eye diagram measured precisely at the output from a tapping device 10 when an Ethernet signal is injected, is shown in FIG. 2. It can be seen that the signal 15 formed from all measurement points 16, that should only pass through zones 17 located between the different parts 18 making up a mask as described in document reference [2], projects onto these parts 18. Therefore the signal is disturbed. It is impossible to spy excessively long links.

The purpose of the invention is to solve such a problem, by preventing any disturbance of links to be spied on, by proposing a method and a device for tapping up data transitting on at least one link to be spied on in an Ethernet network.

### PRESENTATION OF THE INVENTION

The invention relates to a real time interception method for data transported on several links, for example <<full duplex>>, in an Ethernet network, for example AFDX, that comprises:
a simultaneous tapping step for data transferred on transmission and/or reception lines of each of these links using couplers, for example high impedance transformers,
a step to copy, amplify and send these data to at least one test equipment, for example a flight test installation.

The method according to the invention has the following advantages:
no disturbance of the spied link, particularly during switching on and switching off,
environmental resistance (particularly electromagnetic compatibility of tapping),
copy and amplification possible using transceivers,
compatibility with aeronautical constraints,
compatibility with connectors used in aeronautics (ARINC 600, <<quadrax>> contacts),
compatibility with safety requirements.

The invention also relates to a real time interception device for data transported on several links, for example <<full duplex>> in an Ethernet network, for example AFDX that comprises:
means of tapping these data comprising a coupler on each line of each link,
means of copying, amplifying and sending these data to at least one test equipment, for example a flight test installation.

This device may include an interception device or interception devices working in series.

This device may be onboard equipment for use in flight tests to spy links on a 10 or 100 Mbits/s <<full duplex>> AFDX network and capable of copying data transitting on these links without disturbing them.

### BRIEF DESCRIPTION OF THE DRAWINGS

FIG. 1 shows a data interception method according to prior art, for data transiting on a link in an Ethernet network.

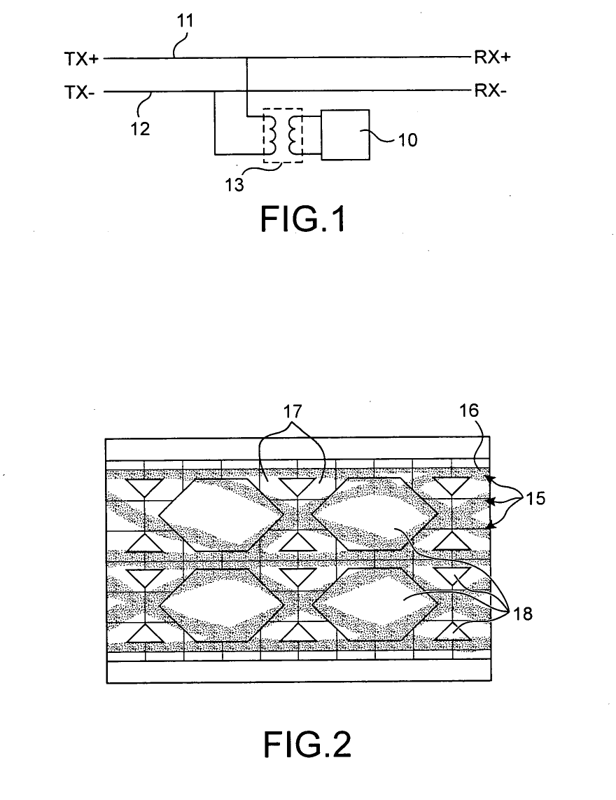

FIG. 2 shows an eye diagram, illustrating the disadvantages of such a method according to prior art.

FIGS. 3 and 4 illustrate a data interception device according to the invention.

FIGS. 5 and 6 illustrate two embodiments of the device according to the invention.

FIG. 7 shows an example embodiment of tapping and copying means in the data interception device according to the invention.

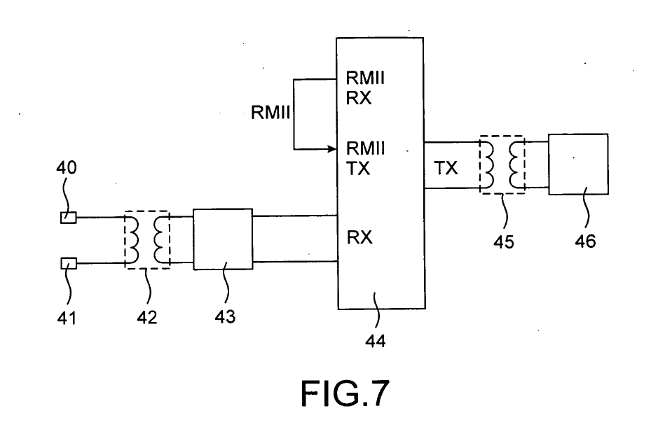

FIG. 8 shows an eye diagram that illustrates the signal quality obtained with the device according to the invention.

### DETAILED PRESENTATION OF PARTICULAR EMBODIMENTS

The invention relates to a method of intercepting data transported on at least one link in an Ethernet network, for example a 10 or 100 Mbits/s AFDX network in which:
data transported on the transmission lines (Tx+ et Tx−) and/or reception lines (Rx+, Rx−) of each link to be spied on in this network are simultaneously tapped using couplers, for example high impedance transformers placed on each line,
these data are copied and amplified using a transceiver for each link, to send them to test equipment, for example a flight test installation, through an insulator.

The method according to the invention provides a means of using components placed in the hold of an aircraft between the different systems in the AFDX network (<<Avionics Data Communication Network>> ADCN). It is used for tapping one or several physical links and for copying data circulating on these links to a flight test installation, this installation being conforming with the ARINC600 2MCU standard, the connectors being of the Quadrax type.

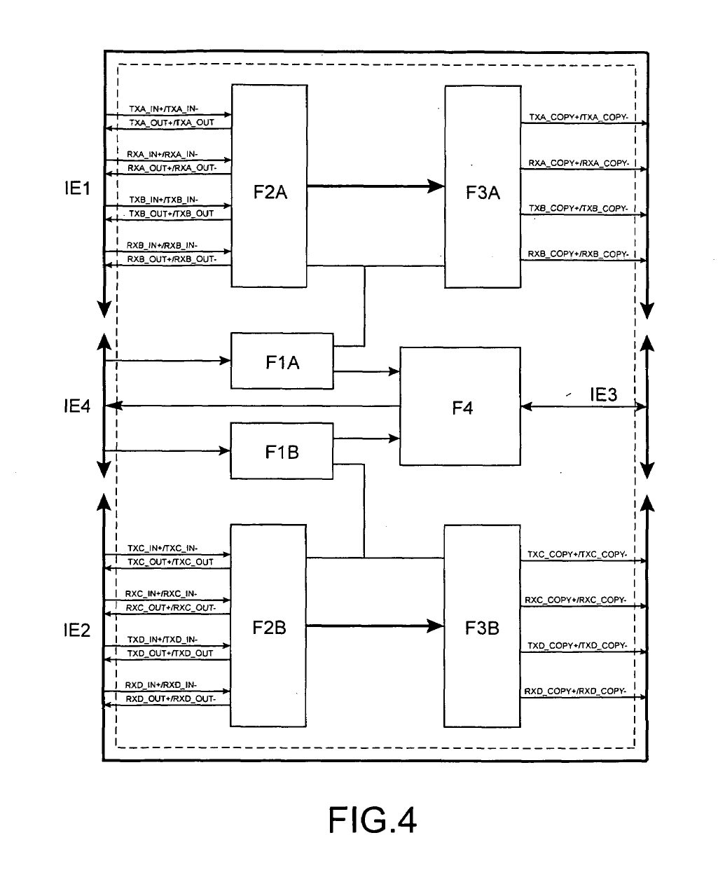

In the embodiment shown in FIG. 3, the data interception device or <<tap>> 20 according to the invention spies four links, for example 10 or 100 Mbits/s <<full duplex>> AFDX LA, LB, LC and LD, and at the same time taps data transmitted in transmission (Tx) and in reception (Rx) between the (<<end systems>>) equipment E1, E2, E3 and E4 and the switches S1, S2, S3 and S4. It also provides a means of copying and amplifying these data to send the data thus obtained (copy A (Tx), Copy A (Rx) . . . copy D (Rx) to a test equipment 21, for example a flight test installation.

The data interception device according to the invention does not disturb the links spied on and is conforming with aeronautical standards DO160 and ABD100.

In one AFDX embodiment, the device according to the invention performs the following functions:
tapping with no loss of integrity of electrical signals from four 10 or 100 Mbits/s full duplex AFDX links (LA, LB, LC, and LD) based on the use of an Ethernet transceiver,
copy these links LA, LB, LC, and LD,
power supply starting from a voltage of 28 V with guaranteed operations if power supply is cutoff for less than 250 ms,
partitioning of the electronic function (power supply, tapping and copy) in two independent parts on a printed circuit,
ARINC600 back panel connector for all inputs—outputs on the card,
quadrax type connectors for integrally copying four links LA, LB, LC and LD simultaneously,
two static relay outputs to signal faults (power supply and fault on one of the AFDX links),
a shunt input to detect presence of the equipment,
light emitting diodes visible on the front face to display the condition of the power supplies.

Thus, in the data interception device according to the invention and shown in FIG. 4, the device shows:
F1A/F1B power supplies,
AFDX F2A/F2B tapping modules,
AFDX F3A/F3B copy modules,
an F4 supervision module,
a first ARINC 600 IE1 external interface,
a second ARINC 600 IE2 external interface,
a third ARINC 600 IE3 external interface,
a front face interface IE4.

The links are thus branch connected onto the flight test installation 21 such that the connections to be made are the same as between two conventional computers. The information tapping device 20 does not disturb the spied link at the time of a power supply cutoff or when switching the device on. The links added for the tests can then be cut off at the end of a flight test campaign on an aircraft, and direct connections between computers can be restored.

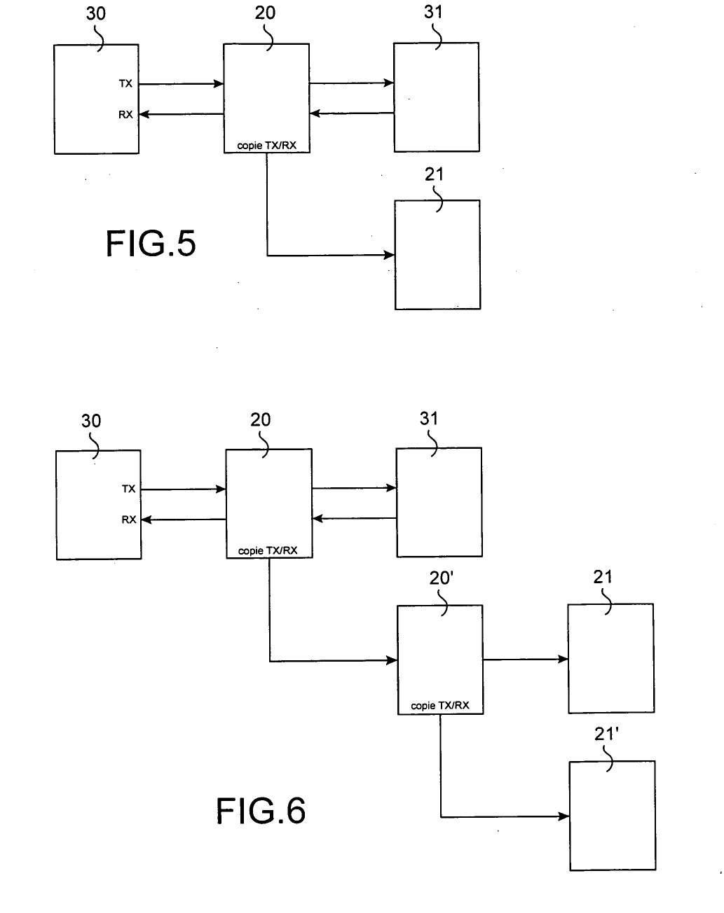

FIGS. 4 and 5 show two embodiments of the data tapping device according to the invention that can be used on an AFDX network:
in a simple copy of data transported on a link between a computer 30 and an AFDX switch 31, as shown in FIG. 4,
in a double copy, using two data tapping devices 20 and 20′ in cascade to send intercepted data to two items of test equipment 21 and 21′ as shown in FIG. 5.

In one example embodiment of the device according to the invention, the sequence of a tapping module (F2A or F2B in FIG. 4) and a copy module (F3A or F3B in FIG. 4) is made for the transmission channel (Tx) of a link through:
an induction coupler 40, 41 for each line Tx+ and Tx−,
an Ethernet insulator 42,
a signal amplifier 43 to compensate attenuation of couplers, for example by 20 dB,
a transceiver 44 that reformats the signal attenuated in the line of the link considered, with infilling of the RM11 Rx digital signal,
an insulator 45 connected to test equipment 46.

Therefore, the intercepted flow converted into digital data is transferred to a test equipment, for example a flight test installation. The same Ethernet transceiver (4 ports) 44 is used to read the intercepted flow at a quadrax connector on the ARINC600 connector, convert it into digital data RM11 Rx, to inject these data onto an RM11 Tx input on the same transceiver to retransmit the data to test equipment 46 through an insulator 45 (therefore a quadri-port can be used to copy two links).

The result is savings of components and a possibility of using a copy over a link length of 100 meters, such a copy being perfectly formatted to the Ethernet standard.

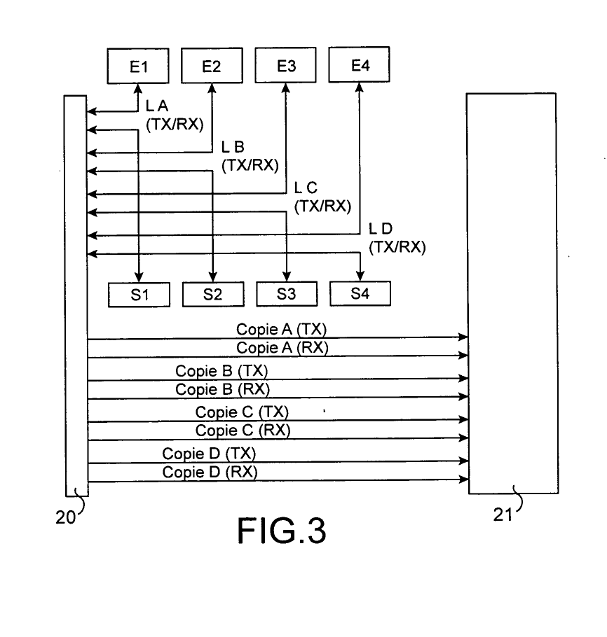

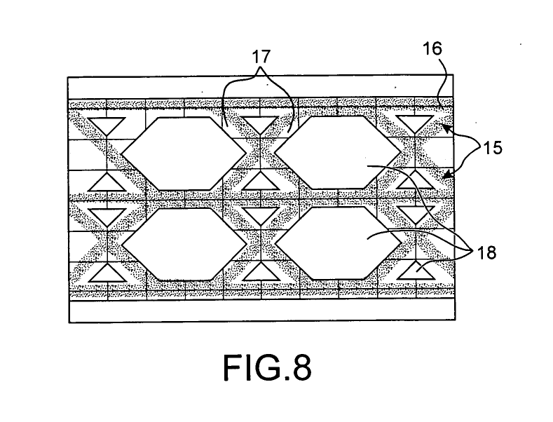

The eye diagram shown in FIG. 8 shows the signal quality after the cutoff. Unlike with diagram shown in FIG. 2, the signal 15 that passes between the mask elements 18 is not disturbed.

In one variant embodiment, the data interception device 20 shown in FIG. 3 copies each data several times and distributes it towards the different items of test equipment. Thus, each line shown in FIG. 3 can thus be duplicated between the data tapping device 20 and the flight test installation 21 in:
copy LA1 (Tx),
copy LA2 (Tx),
copy LA1 (Rx),
copy LA2 (Rx),
etc.

### REFERENCES

[1] http://www.shomiti.net/shomiti/century-tap.html. (Shomiti Systems, <<Century Tap Family>>, 2000)

[2] American National Standard ANSO X3.263-1995 (Appendix J, page 67, <<Twisted pair active output interface template>>)

1. Real time interception method for data transported on several links in an Ethernet network, comprising:
a simultaneous tapping step for data transferred on transmission and/or reception lines of each of these links using couplers,
a step to copy, amplify and send these data to at least one test equipment.

2. Method according to claim 1, which makes use of one interception device, or several interception devices in cascade.

3. Method according to claim 1, in which the Ethernet network is an AFDX 10 or 100 Mbits/s network.

4. Method according to claim 1, in which the links are <<full duplex>> links.

5. Method according to claim 1, in which couplers are high impedance transformers.

6. Method according to claim 1, in which each transceiver is a four-port transceiver.

7. Method according to claim 1, in which the test equipment is a flight test installation.

8. Real time interception device for data transported on several links in an Ethernet network, which comprises:
means of tapping these data comprising a coupler on each line of each link,
means of copying, amplifying and sending these data to at least one test equipment.

9. Device according to claim 8, which comprises one interception device or several interception devices in cascade.

10. Device according to claim 8, in which the Ethernet network is an AFDX 10 or 100 Mbits/s network.

11. Device according to claim 8, in which the links are <<full duplex>> links.

12. Device according to claim 8, in which couplers are high impedance transformers.

13. Device according to claim 8, in which each transceiver is a four-port transceiver.

14. Device according to claim 8, in which the test equipment is a flight test installation.
